(19) United States
(12) Patent Application Publication
(10) Pub. No.: US 2026/0233715 A1
(43) Pub. Date: Aug. 13, 2026

(54) VEHICLE BRAKE SYSTEM WITH MIXED BRAKE TYPES

(71) Applicant: HL MANDO CORPORATION, Gyeonggi-do (KR)

(72) Inventors: Christian ROSS, Auburn, MI (US); Tomy SEBASTIAN, Auburn, MI (US); Raja RAMAKRISHNAN, Auburn, MI (US); Dheerajkumar PATEL, Auburn, MI (US); Lucas RITTER, Auburn, MI (US); Shakil HOSSAIN, Auburn, MI (US); Jonathan KNIEPER, Auburn, MI (US)

(21) Appl. No.: 19/457,917

(22) Filed: Jan. 23, 2026

Related U.S. Application Data
(60) Provisional application No. 63/758,316, filed on Feb. 13, 2025.

(51) Int. Cl. B60T 8/17

(52) U.S. Cl. CPC B60T 8/17; B60T 2270/414; B60T 2270/82

(57) ABSTRACT

A brake system for a vehicle is provided. The brake system includes: two first-type brakes connected to a first set of wheels of the vehicle; two second-type brakes connected to a second set of wheels of the vehicle; a brake controller configured to control the two first-type brakes and the two second-type brakes; and a single power source configured to power the two first-type brakes, the two second-type brakes, and the brake controller. The two second-type brakes are configured to be fully non-operational for performance of braking of the vehicle during a failure of the single power source.

### CROSS REFERENCE TO RELATED PATENT APPLICATION(S)

This application claims the benefit of U.S. patent application Ser. No. 63/758,316, filed on Feb. 13, 2025, entitled “FRONT IDB & REAR EMB VEHICLE ARCHITECTURE”, which is all hereby incorporated by reference in its entirety.

### BACKGROUND

Various embodiments of the present disclosure generally relate to a brake system for a vehicle and more particularly to a vehicle brake system with mixed brake types.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock, and electric or brake-by-wire brake systems. For example, in a hydraulic brake system, the hydraulic fluid transfers energy from a brake pedal to a brake pad for slowing down or stopping rotation of a wheel of the vehicle. Electronics control the hydraulic fluid in the hydraulic brake system. In an electric brake system, the application and release of the brake is controlled by an electric caliper or motor via an electrical signal.

These electric brake systems typically include an electro-mechanical actuator connected to a brake caliper either by a cable, as the drum in head, or directly attached to the brake caliper. The actuator converts electrical power to rotational mechanical output power for moving the cable or drive screw and applying the brakes. Generally, the electro-mechanical actuator includes an electric motor and a mechanical assembly for achieving the necessary load transfer.

It is with respect to these and other general considerations that the following embodiments have been described. Also, although relatively specific problems have been discussed, it should be understood that the embodiments should not be limited to solving the specific problems identified in the background.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, a brake system for a vehicle may comprise: two first-type brakes connected to a first set of wheels of the vehicle; two second-type brakes connected to a second set of wheels of the vehicle; a brake controller configured to control the two first-type brakes and the two second-type brakes; and a single power source configured to power the two first-type brakes, the two second-type brakes, and the brake controller, wherein the two second-type brakes are configured to be fully non-operational for performance of braking of the vehicle during a failure of the single power source.

The two first-type brakes are integrated dynamic brakes (IDBs) and the two second-type brakes are electromechanical brakes (EMBs).

The brake controller comprises an Electronic Brake Control Module (EBCM).

The EBCM is a 2-channel IDB brake controller.

Each of the two EMBs is connected to the EBCM via private communication channels.

The private communication channels are private controller area network (CAN) buses.

The private CAN buses are separate from communication lines connecting the two EMBs to a chassis controller of the vehicle.

The brake system conforms to R13H global braking specification failure condition performance requirements.

During the failure of the single power source, the braking of the vehicle is provided solely by the two first-type brakes using a hydraulic system of the vehicle that connects a brake pedal of the vehicle to the brake controller and the two first-type brakes.

The first set of wheels comprises two front wheels of the vehicle, and the second set of wheels comprises two rear wheels of the vehicle.

The brake system is a brake-by-wire brake system.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 is a diagram illustrating a brake system of a vehicle according to an exemplary embodiment of the present disclosure.

FIG. 2 is an implementation example of the brake system of FIG. 1 according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

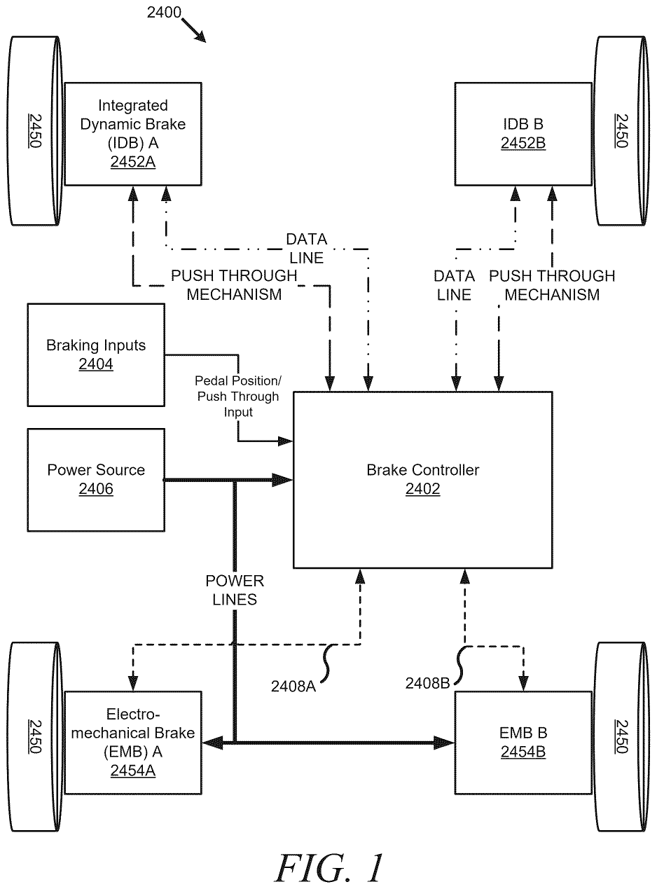

Turning now to FIG. 1, FIG. 1 shows a brake system 2400 of a vehicle (i.e., a motor vehicle) according to an exemplary embodiment of the present disclosure. In embodiments, the brake system 2400 of FIG. 1 is compatible with any type of steering systems (e.g., steer-by-wire, power steering, rack and pinion steering, recirculating ball steering, hydraulic power steering, electric power steering, manual steering, or the like). When used in a vehicle with the steer-by-wire system, the brake system 2400 of FIG. 1 may be configured a brake-by-wire brake system.

As shown in FIG. 1, the brake system 2400 may have two types of brakes connected to the road wheels 2450 of a vehicle. In embodiments, a first type of brakes (also referred to herein as “first-type brakes”) may be integrated dynamic brakes (IDBs) 2452A and 2452B. The second type of brakes (also referred to herein as “second-type brakes”) may be electromechanical brakes (EMBs) 2454A and 2454B. All of the brakes (i.e., IDB A 2452A, IDB B 2452B, EMB A 2454A, and EMB B 2454B) are powered using a single power source 2406 (e.g., a main battery of the vehicle, or the like) and controlled using a brake controller 2402 that receives braking inputs 2404 from the driver and/or vehicle (e.g., in autonomous driving situations).

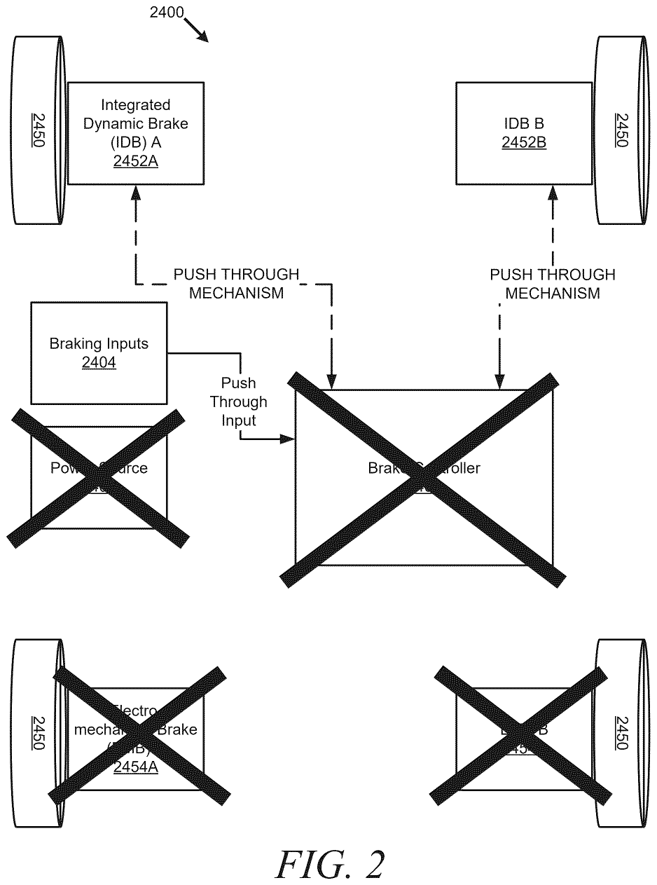

In embodiments, the brake controller 2402 may be configured using an Electronic Brake Control Module (EBCM). More specifically, the EBCM may be configured as a 2-channel (2-CH) IDB EBCM. The brake controller 2402 may receive any type of braking operation and inputs as the braking inputs 2404. For example, the braking operation and inputs may include, but are not limited to: pedal position of the brake pedal, vehicle speed, push through inputs, or the like. In embodiments, the brake controller 2402 may be a separate electrical control unit (ECU) from the other ECUs (e.g., a main chassis controller (not shown in FIGS. 1 and 2), or the like) of the motor vehicle. For example, the brake controller 2402 may be solely for controlling the brake system 2400 and is separate from a main controller (e.g., a chassis controller or the like) of the vehicle.

In embodiments, the brake controller 2402 may also be configured as, for example, but not limited to, a micro-controller unit (MCU), a circuit chip, a semiconductor circuit, and a circuit board having memory (e.g., for storing instructions to be executed by one or more processors coupled to the memory), one or more processors, and electric components.

In embodiments, the IDBs (i.e., 2452A and 2452B) may be any type of IDBs with both electronic and mechanical (e.g., hydraulic, or the like) control capabilities. For example, the IDBs may be a brake system that combine traditional brake components (like master cylinder, booster, Anti-lock Braking System (ABS), and Electronic Stability Control (ESC)) into a single unit, often using electric or electro-hydraulic power. The IDBs (i.e., 2452A and 2452B) may be HL Mando's IDB2 Base integrated dynamic brakes. Each of the IDBs (i.e., 2452A and 2452B) may receive the braking inputs 2404 from the brake controller 2402 via a respective data line configured to communicate signals (i.e., data signals) to and from the IDBs (i.e., 2452A and 2452B) to the brake controller. Each of the IDBs (i.e., 2452A and 2452B) may also be configured with a push through mechanism (e.g., hydraulic control, or the like) that can be utilized in case of power failure of the power source 2406.

In the example shown in FIG. 1, the brake system 2400 of embodiments disclosed herein is configured to have the IDBs (i.e., 2452A and 2452B; the first-type brakes) installed on the set of front wheels (also referred to herein as “a first set of wheels”) of the vehicles.

The EMBs (i.e., 2454A and 2454B) may be any type of electromechanical brake (also referred to in the field as “electro-mechanical brake”) systems that utilizes a brake-by-wire system that uses electric motors at each wheel to apply braking force while completely replacing hydraulic fluid and mechanical linkages. The EMBs (i.e., 2454A and 2454B) may be configured to include parking brakes, and may be configured to receive power (i.e., via the power lines shown in FIG. 1) from the power source 2406. Other types of brakes that are similar in nature to EMBs (namely, that do not include any hydraulic fluid and mechanical linkages) may also be used as the second-type brakes without departing from the scope of embodiments disclosed herein.

In embodiments, because of the lack of hydraulic fluid and mechanical linkages, should the power source 2406 (i.e., the sole power source of the vehicle) fail, the EMBs (i.e., 2454A and 2454B) will also fail and become non-operational such that neither of the EMBs (i.e., 2454A and 2454B) will be able to provide any braking capabilities for a braking operation of the vehicle. Said another way, if either one of the EMBs (i.e., 2454A and 2454B) lose power, EMB that lost power will not be able to provide any braking capabilities for the vehicle.

Conversely, because of the push through mechanism (e.g., hydraulic control, or the like) available to the IDBs (i.e., 2452A and 2452B), both of the IDBs (i.e., 2452A and 2452B) will still be functional (i.e., operational) and still be able to provide braking capabilities for the vehicle even if power is lost to these IDBs (i.e., 2452A and 2452B). Said another way, should the power source 2406 fail, the IDBs (i.e., 2452A and 2452B) will still be able to use the push through mechanism to provide braking capabilities for the vehicle. In embodiments, the push through mechanism may be configured as a hydraulic system and may be activated upon depressing of the brake pedal by a driver (and/or automatically by the vehicle in an autonomous vehicle setting). Other types of push through mechanisms similar in nature to the hydraulic system/hydraulic control may also be used without departing from the scope of embodiments disclosed herein. Other types of brakes that are similar in nature to IDBs (namely, that include a push through mechanism that allows the brakes to still be operational and provide braking capabilities even during a loss of electrical power to the brakes) may also be used as the first-type brakes without departing from the scope of embodiments disclosed herein.

Each of the EMBs (i.e., 2454A and 2454B) may also communicate with the brake controller 2402 (e.g., to receive the braking inputs 2404, to provide operational data to the brake controller 2402, or the like) using respective communication channels 2408A and 2408B established between each EMB (i.e., 2454A and 2454B) and the brake controller 2402. Each of the communication channels 2408A and 2408B may be configured using private controller area network (CAN) buses. Other types of communication channels (e.g., Ethernet, or the like) may also be used instead of the private CAN buses without departing from the scope of embodiments disclosed herein.

In the example shown in FIG. 1, the brake system 2400 of embodiments disclosed herein is configured to have the EMBs (i.e., 2454A and 2454B; the second-type brakes) installed on the set of rear wheels (also referred to herein as “a second set of wheels”) of the vehicles.

Such a configuration of the brake system 2400 of embodiments disclosed herein not only advantageously allows the brake system 2400 to be powered using a single power source (e.g., the main battery of the vehicle, or the like) but also provides a “fail safe” state where at least two brakes (namely, the two first-type brakes installed on the set of front wheels) to still provide sufficient braking capabilities for the vehicle should the vehicle lose power (i.e., should power be lost to the EMBs (i.e., 2454A, 2454B) installed as the second-type brakes on the set of rear wheels).

Thus, even with such a configuration of a brake system 2400 that includes two different brake types (namely, a first type with a push through mechanism that can still operate when the brakes lose electrical power and a second type without the push through mechanism that will become fully in-operational/non-operational when the brakes lose electrical power), the brake system can still advantageously meet (i.e., conform to) R13H global braking specification failure condition performance requirements. Additionally, such a configuration of a brake system 2400 that includes these two types of brakes advantageously allows the vehicle to only have a single power source 2406 (i.e., the main vehicle battery) that is used by all components of the vehicle (i.e., all components of the brake system 2400 and all other components installed within the vehicle besides the components of the brake system 2400) while still being able to meet R13H global braking specification failure condition performance requirements for vehicle braking and safety performance. Thus, the use of two different types of brakes is not just a mere substitution of parts (e.g., brake types) but instead a carefully planned and meticulously designed aspect (i.e., a criticality) of embodiments disclosed herein. Such use of two different types of brakes is also an improvement over conventional systems that require all brakes of a vehicle to be a same brake type (e.g., either all IDBs or all EMBs on all of the wheels of the vehicle).

Turning now to FIG. 2, an implementation example of the brake system 2400 of FIG. 1 according to an exemplary embodiment of the present disclosure.

As shown in FIG. 2, assume that the power source 2406 has failed. As a result of this failure, further assume that electrical power to components of the vehicle is now completely lost and that: (i) the EMBs (i.e., 2454A and 2454B) can no longer function (i.e., can no longer provide braking capabilities for the vehicle to the stop the wheels 2450 to which they are installed/attached); (ii) the electronic components of the brake controller 2402 (e.g., components that process, receive, and transmit data and electrical command signals) are no longer operational.

In such a state, the only way to stop the vehicle would be to use the push through mechanism of the IDBs (i.e., 2452A and 2452B). For example, further assume here that the push through mechanism is a hydraulic system (e.g., hydraulic brake control system, or the like). The only way to stop the vehicle would be through the driver depressing (i.e., stepping on) the brake pedal to trigger the hydraulic braking capabilities of the IDBs (i.e., 2452A and 2452B). More specifically, in case of power failure to the brake system 2400 (and/or to the entire vehicle), the IDBs (i.e., 2452A and 2452B) installed on the set of front wheels will provide the performance (i.e., braking performance) needed for secondary braking using mechanical push through (i.e., using the push through mechanism capabilities of the IDBs (i.e., 2452A and 2452B)).

As a result, even with such a configuration of a brake system 2400 that includes two different brake types (namely, a first type with a push through mechanism that can still operate when the brakes lose electrical power and a second type without the push through mechanism that will become fully in-operational/non-operational when the brakes lose electrical power), the brake system can still advantageously meet (i.e., conform to) R13H global braking specification failure condition performance requirements.

Although the example embodiments have been described in detail, it should be understood that various changes, substitutions and alterations can be made herein without departing from the spirit and scope of the application as defined by the appended claims.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

What is claimed is:

1. A brake system for a vehicle, the brake system comprising:
two first-type brakes connected to a first set of wheels of the vehicle;
two second-type brakes connected to a second set of wheels of the vehicle;
a brake controller configured to control the two first-type brakes and the two second-type brakes; and
a single power source configured to power the two first-type brakes, the two second-type brakes, and the brake controller, wherein the two second-type brakes are configured to be fully non-operational for performance of braking of the vehicle during a failure of the single power source.

2. The brake system of claim 1, wherein the two first-type brakes are integrated dynamic brakes (IDBs) and the two second-type brakes are electromechanical brakes (EMBs).

3. The brake system of claim 2, wherein the brake controller comprises an Electronic Brake Control Module (EBCM).

4. The brake system of claim 3, wherein the EBCM is a 2-channel IDB brake controller.

5. The brake system of claim 3, wherein each of the two EMBs are connected to the EBCM via private communication channels.

6. The brake system of claim 5, wherein the private communication channels are private controller area network (CAN) buses.

7. The brake system of claim 6, wherein the private CAN buses are separate from communication lines connecting the two EMBs to a chassis controller of the vehicle.

8. The brake system of claim 2, wherein the brake system conforms to R13H global braking specification failure condition performance requirements.

9. The brake system of claim 8, wherein during the failure of the single power source, the braking of the vehicle is provided solely by the two first-type brakes using a hydraulic system of the vehicle that connects a brake pedal of the vehicle to the brake controller and the two first-type brakes.

10. The brake system of claim 2, wherein the first set of wheels comprises two front wheels of the vehicle, and the second set of wheels comprises two rear wheels of the vehicle.

11. The brake system of claim 10, wherein the brake system is a brake-by-wire brake system.
